(19) United States
(12) Patent Application Publication
(10) Pub. No.: US 2010/0232083 A1
(43) Pub. Date: Sep. 16, 2010

(54) Trimmer Capacitor

(76) Inventors: Mark Alan Imbimbo, Butler, NJ (US); Ronald Joseph Vecchio, Morris Plains, NJ (US)

Correspondence Address: MCCARTER & ENGLISH, LLP NEWARK, FOUR GATEWAY CENTER, 100 MULBERRY STREET, NEWARK, NJ, 07102, US

(21) Appl. No.: 12/404,733

(22) Filed: Mar. 16, 2009

(51) Int. Cl. H01G 5/12; H01G 5/14

(52) U.S. Cl. 361/295; 29/25.42

(57) ABSTRACT

A trimmer capacitor is provided which includes a conductive bushing having a first terminal of the capacitor formed integrally therewith, a rotor threadably engageable with the bushing, and a dielectric portion attached at one end to the bushing and having a metallized stator surrounding the dielectric portion near the opposite end thereof. The metallized stator forms the second terminal of the capacitor, and is positioned above the bottom edge of the dielectric portion. The rotor includes transverse slots which bias the rotor in position against the bushing, to prevent undesired rotation of the rotor.

### BACKGROUND OF THE INVENTION

1. Field of the Invention

The present invention relates to a trimmer capacitor.

2. Related Art

Capacitors are passive electrical devices which store electrical charge. Most capacitors consist of two conductors insulated from each other by a dielectric, whereby electrical charge is stored on the conductors. Often, capacitors are used in filtration applications, such as in power supplies and in radio frequency (RF) circuits.

A common type of capacitor is the “trimmer” capacitor, the capacitance of which can be varied by adjusting a portion of the capacitor (e.g., by turning a screw). Often, trimmer capacitors are used to make precise adjustments to the capacitance of a circuit, such as in microwave transceiver applications. In such applications, the trimmer capacitor can be used to adjust the resonance of an RF circuit (i.e., to “tune” the circuit) to a desired frequency.

It is known to provide a trimmer capacitor having a conductive bushing, a first terminal attached to the bushing, a rotor threadably engaged to the bushing, a cylindrical dielectric portion attached at one end to the conductive bushing, and a stator attached at an opposite end of the dielectric portion, wherein the stator serves as the second terminal of the capacitor. The capacitance of such a device can be adjusted by selectively turning the rotor, which causes the rotor to advance toward or away from the stator. By varying the distance between the rotor and the stator, the capacitance of the device is adjusted.

There are, however, drawbacks associated with this design, in that there are a number of components that are made separately and assembled.

### SUMMARY OF THE INVENTION

The present invention relates to a trimmer capacitor. The capacitor includes a conductive bushing having a first terminal of the capacitor formed integrally therewith, a rotor threadably engageable with the bushing, and a dielectric portion attached at one end to the bushing and having a metallized stator surrounding the dielectric portion near an opposite end of the dielectric portion. The metallized stator forms the second terminal of the capacitor, and is positioned above the bottom edge of the dielectric portion. Capacitance can be adjusted by selectively rotating the rotor, which causes the rotor to move toward or away from the stator. The rotor includes transverse slots which bias the rotor in position against the bushing, to prevent undesired rotation of the rotor. The trimmer capacitor provides manufacturing and cost advantages because it is formed from fewer components than existing trimmer capacitors.

The present invention also relates to a method for manufacturing a trimmer capacitor. The method includes the steps of forming a bushing having an integral terminal and a threaded inner surface, forming a cylindrical dielectric portion, forming a metallized stator on an outer surface of the cylindrical dielectric portion, forming a rotor, attaching one end of the dielectric portion to one end of the bushing, and threading the rotor into the bushing.

### BRIEF DESCRIPTION OF THE DRAWINGS

The foregoing features of the invention will be apparent from the following Detailed Description of the Invention, taken in connection with the accompanying drawings, in which:

FIG. 1 is a side view showing the trimmer capacitor of the present invention;

FIG. 2 is a top view of the trimmer capacitor shown in FIG. 1; and

FIGS. 3-4 are cross-sectional views showing operation of the trimmer capacitor of the present invention.

### DETAILED DESCRIPTION OF THE INVENTION

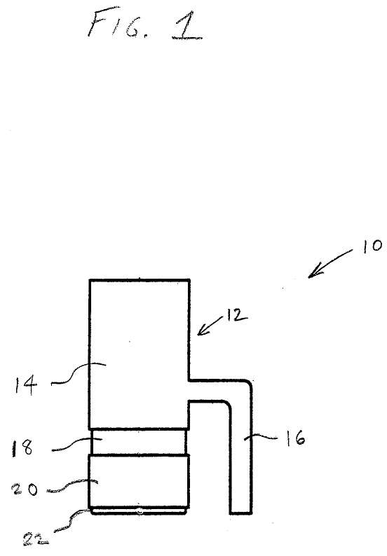

The present invention relates to a trimmer capacitor, as discussed in detail below in connection with FIGS. 1-4.

FIG. 1 is a side view showing the trimmer capacitor of the present invention, indicated generally at 10. The trimmer capacitor 10 includes a conductive bushing 12 having a cylindrical body 14 and a first terminal 16 formed integrally with and extending from the body 14, a cylindrical dielectric portion 18, and a stator 20 formed on an outer surface of the dielectric portion 18. The stator 20 provides a second terminal for the capacitor 10, and is formed so that a lower portion 22 of the dielectric portion 18 is exposed, i.e., the stator 20 is formed above the bottom edge of the dielectric portion 18. As can be seen in the Figures, the stator 20 could comprise a cylindrical band about the dielectric portion 18. This provides installation advantages, such that the stator 20 can be directly soldered to a printed circuit board. The stator 20 could be formed directly on a portion of the outer surface of the dielectric portion 18 using a suitable metallization process.

Advantageously, by forming the first terminal 16 integrally with the bushing 12, manufacturing steps and costs are reduced. Of course, it is noted that the first terminal 16 need not be formed integrally with the bushing 12, and could be formed separately from the bushing 12 and subsequently attached thereto (e.g., by way of a collar extending from the first terminal 16 and press-fit over a bulge on the bushing 12). As will be discussed below, the bushing 12 includes internal threads for threadably receiving a rotor which can be selectively rotated with respect to the bushing 12 to adjust the capacitance of the capacitor 12.

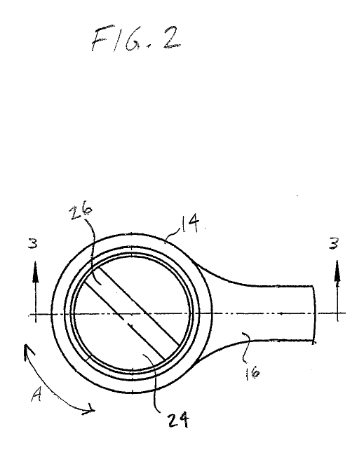

FIG. 2 is a top view of the trimmer capacitor 10 shown in FIG. 1. A rotor 24 is received by, and is threadably engageable with, the body 14 of the bushing 12, and can be selectively rotated with respect to the body 14 (as indicated by arrow A) to adjust the capacitance of the capacitor 10. A slot 26 could be provided for accepting a screwdriver or other tool, which could be used to rotate the rotor 24. Of course, any other type of engagement between the rotor 24 and an operating tool (e.g., Phillips-style slot, hexagonal recess, etc.) could be provided without departing from the spirit or scope of the present invention.

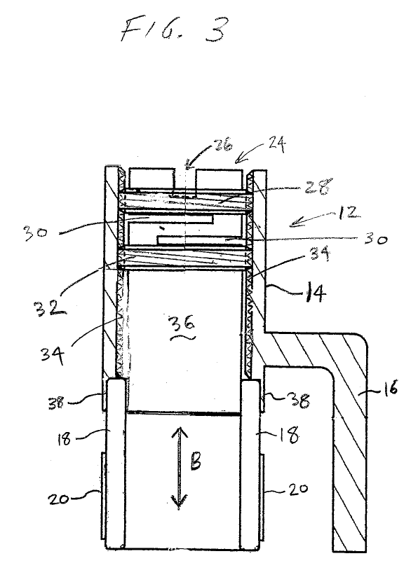

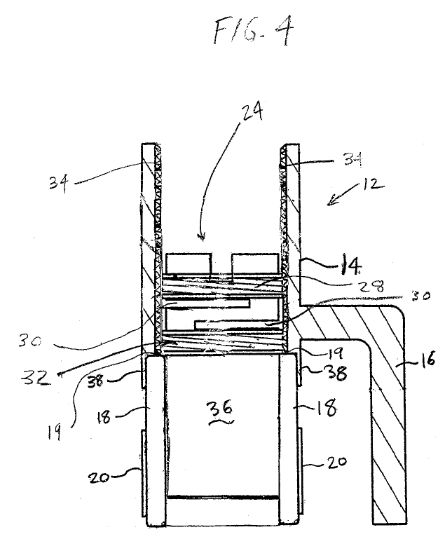

FIGS. 3-4 are cross-sectional views showing operation of the trimmer capacitor of the present invention. As seen in FIG. 3 (taken along the line 3-3 of FIG. 2), the body 14 of the bushing 12 includes a threaded inner surface 34 which receives upper and lower threaded portions 28 and 32 of the rotor 24. The upper and lower threaded portions 28 and 32 are separated by an unthreaded portion. One or more transverse slots 30 could be provided in the unthreaded portion of the rotor 24, such that the upper threaded portion 28 is slightly offset with respect to the lower threaded portion 32. Such an arrangement causes the threaded portions 28, 32 to be biased against the threaded inner surface 34, so that unwanted rotation of the rotor 24 is reduced. The body 14 of the bushing 12 includes an annular recess 38 for receiving an upper end of the dielectric portion 18. The dielectric portion 18 could be held in place in the annular recess 38 by way of a friction fit between the dielectric portion 18 and the annular recess 38. It could also be held in place by an adhesive (e.g., epoxy).

The rotor 24 also includes a cylindrical portion 36 which extends from the lower threaded portion 32 and is received by the dielectric portion 18. The cylindrical portion 36 could be solid or hollow, and is in electrical communication with the bushing 12 by way of the threaded upper and lower portions 28, 32. When the rotor 24 is rotated, the cylindrical portion 36 is selectively advanced toward or away from the stator 20, as indicated by arrow B. This causes the capacitance of the device to be adjusted as desired. As shown in FIG. 4, the rotor 24 can be advanced (rotated) to a final position, such that the threaded lower portion 32 rests against a shoulder 19 of the dielectric portion 18 and the cylindrical portion 36 is positioned entirely within the dielectric portion 18. The shoulder 19 prevents the rotor 24 from traveling past the threads 34 of the bushing 12, and also prevents the cylindrical portion 36 from contacting a printed circuit board (and “shorting out” of the capacitor 10).

The bushing 12 and rotor 24 could be formed from any suitable conductive metal, such as brass, and could be non-magnetic. The dielectric portion 18 could be formed from any suitable dielectric material, including, but not limited to, alumina (Al₂O₃), zirconia, or sapphire. The stator 20 could be formed from moly-manganese, copper, tin plate, or any other suitable material. As mentioned above, the stator 20 could be formed directly on the outer surface of the dielectric portion 18 using a suitable metallization process.

The trimmer capacitor 10 could be formed using the following manufacturing steps. First, the bushing 12 (including the cylindrical body 14 and integral first terminal 16) could be formed using a precision milling process. Then, the rotor 24 could be formed using precision milling processes. Once the dielectric portion 18 is formed by pressing and sintering, the stator 20 could be formed on a portion of the outer surface of the dielectric portion 18 using a metallization process. Once the stator 20 is formed, one end of the dielectric portion 18 is fit into the annular recess 38 of the bushing 12. The dielectric portion 18 could be attached to the bushing 12 by way of a frictional fit, or by an adhesive (e.g., epoxy) applied to the annular recess 38 before insertion of the dielectric portion 18. When the dielectric portion 18 is attached to the bushing 12, the rotor 24 is threaded into the bushing 12, forming a complete trimmer capacitor in accordance with the present invention.

The trimmer capacitor of the present invention could have a wide range of operating frequencies. For example, an operating frequency range of 800 MHz to 2.1 GHz is possible, which is advantageous for usage of the trimmer capacitor in various RF applications including WiMax, cellular telephony, and global positioning system (GPS) applications. A capacity range of 0.5 to 2.5 picofarads (pF) could be provided, which corresponds roughly to 8 full rotations of the rotor of the rotor of the trimmer capacitor. A working voltage of 500 volts direct current (DC) could be provided, with a test voltage of 1,000 volts DC. The capacitor could have a quality (“Q”) rating of greater than 3,000, and an insulation resistance of greater than 10⁶ megohms. An operating temperature range of −65 degrees Celsius to +125 degress Celsius is possible, and the rotor of the trimmer capacitor can be operated with torque in the range of 0.2 to 2.0 oz.-inch. Moisture resistance ratings of 10-24 hour cycles is also possible. These operational parameters could be varied without departing from the spirit or scope of the present invention.

Having thus described the invention in detail, it is to be understood that the foregoing description is not intended to limit the spirit or scope thereof. What is desired to be protected is set forth in the following claims.

What is claimed is:

1. A trimmer capacitor, comprising:
a bushing having a threaded inner surface and a first terminal;
a dielectric portion attached at one end to the bushing;
a metallized stator formed on an outer surface of the dielectric portion, the metallized stator forming a second terminal of the capacitor; and
a rotor threadably engageable with the threaded inner surface of the bushing, the rotor including at least one transverse slot for biasing the rotor against the threaded inner surface of the bushing,
wherein the rotor is selectively rotatable to move the rotor with respect to the stator to adjust a capacitance of the capacitor.

2. The capacitor of claim 1, wherein the first terminal is formed integrally with the bushing.

3. The capacitor of claim 1, wherein the rotor includes upper and lower sets of threads separated by an unthreaded portion.

4. The capacitor of claim 3, wherein the at least one transverse slot is positioned in the unthreaded portion.

5. The capacitor of claim 3, wherein the upper set of threads is offset with respect to the lower set of threads to bias the rotor against the threaded inner surface of the bushing.

6. The capacitor of claim 3, wherein the rotor includes a cylindrical portion extending from the lower set of threads and positioned at least partially within the dielectric portion.

7. The capacitor of claim 6, wherein the cylindrical portion is selectively advanceable toward or away from the stator by rotating the rotor to adjust the capacitance of the capacitor.

8. The capacitor of claim 1, further comprising an exposed portion about a lower perimeter of the dielectric portion which separates the metallized stator from a lower edge of the dielectric portion.

9. The capacitor of claim 1, wherein the bushing includes an annular recess for receiving an end of the dielectric portion.

10. The capacitor of claim 1, wherein an upper edge of the dielectric portion includes a shoulder for limiting rotation of the rotor.

11. A method for manufacturing a trimmer capacitor, comprising the steps of:
forming a bushing having a threaded inner surface and a first terminal, a dielectric portion, and a rotor;
metallizing a stator on a portion of an outer surface of the dielectric portion, the metallized stator functioning as a second terminal of the capacitor;
attaching an end of the dielectric portion to the bushing; and
threading the rotor into the bushing.

12. The method of claim 11, wherein the step of forming the bushing comprises forming the first terminal integrally with the bushing.

13. The method of claim 11, wherein the step of forming the bushing comprises forming an annular recess within one end of the bushing.

14. The method of claim 13, wherein the step of attaching the end of the dielectric portion to the bushing comprises inserting the end of the dielectric portion into annular recess.

15. The method of claim 16, wherein the step of attaching the end of the dielectric portion to the bushing comprises frictionally retaining the end of the dielectric portion in the annular recess.

16. The method of claim 13, wherein the step of attaching the end of the dielectric portion to the bushing comprises applying an adhesive to the annular recess prior to inserting the end of the dielectric portion into the annular recess.

17. The method of claim 13, wherein the step of forming the rotor comprises the step of forming a rotor including a cylindrical body, upper and lower sets of threads, and at least one slot separating the upper and lower sets of threads.
